(19) United States
(12) Patent Application Publication
(10) Pub. No.: US 2018/0275391 A1
(43) Pub. Date: Sep. 27, 2018

(54) OPTICAL UNIT AND ENDOSCOPE

(71) Applicant: OLYMPUS CORPORATION, Tokyo (JP)

(72) Inventor: Tadashi ITO, Tokyo (JP)

(73) Assignee: OLYMPUS CORPORATION, Tokyo (JP)

(21) Appl. No.: 15/992,743

(22) Filed: May 30, 2018

Related U.S. Application Data
(63) Continuation of application No. PCT/JP2015/083818, filed on Dec. 1, 2015.

(51) Int. Cl. G02B 23/24; G02B 7/10

(52) U.S. Cl. CPC G02B 23/2438; G02B 23/26; G02B 7/10

(57) ABSTRACT

An optical unit includes a main unit holding an anterior frame holding a first lens and a rear frame holding a second lens; a movable portion holding a movable lens between the first and second lenses or the image sensor and being slidable against the main unit; a voice coil motor including a magnetic portion disposed in the movable portion and polarized in a direction intersecting an optical axis of the first lens, and a coil positioned on an outside in the radial direction of the main unit; and a biasing member biasing the movable portion to be closer to the main unit, using magnetic force caused by the magnetic portion. In the main unit, a first dimension in a first direction parallel to a magnetization direction of the magnetic portion exceeds a second dimension in a second direction perpendicular to the first direction and the optical axis.

### CROSS-REFERENCE TO RELATED APPLICATION

This application is a continuation of International Application No. PCT/JP2015/083818, filed on Dec. 1, 2015, the entire contents of which are incorporated herein by reference.

### BACKGROUND OF THE INVENTION

### 1. Field of the Invention

The present disclosure relates to an optical unit and an endoscope that drives a movable portion forward and backward, using a voice coil motor.

### 2. Description of the Related Art

In the past, there has been disclosed a technology that uses an electromagnetic actuator, or a voice coil motor, that includes a movable lens frame provided with a group of movable lenses. By driving the movable lens frame forward and backward by use of a coil and a magnet (e.g., refer to JP 5031666 B2), a zooming function for changing an imaging magnification and a focusing function for adjusting focus are demonstrated. The zoom function and the focus function can be utilized in an endoscope including an insertion portion to be inserted into a subject, for example.

### SUMMARY OF THE INVENTION

According to an aspect of the present disclosure, there is provided an optical unit comprising: a fixing unit including an anterior frame holding an object side fixed lens group, a rear frame holding an image side fixed lens group or an image sensor, and a fixing unit main body holding the anterior frame and the rear frame; a movable portion holding a movable lens group between the object side fixed lens group and the image side fixed lens group or the image sensor, the movable portion being disposed on an inner side in a radial direction of the fixing unit main body and slidable with respect to the fixing unit main body; a voice coil motor that allows the movable portion to move along a direction of the optical axis relative to the fixing unit main body, the voice coil motor including: a magnetic portion being disposed in the movable portion and magnetically polarized in a direction intersecting with an optical axis of the object side fixed lens group; and a coil being disposed in the fixing unit main body and positioned on an outside in the radial direction of the fixing unit main body with respect to the magnetic portion, and a biasing member configured to bias the movable portion in a direction in which the movable portion moves closer to the fixing unit main body, by attracting force generated between the magnetic portion and the biasing member, wherein, in the fixing unit main body, a first dimension in a first direction parallel to a magnetization direction of the magnetic portion is longer than a second dimension in a second direction perpendicular to the first direction and the direction of the optical axis. The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a perspective view illustrating a configuration of an optical unit according to a first embodiment of the present disclosure;

FIG. 2 is an exploded perspective view illustrating a configuration of the optical unit according to the first embodiment of the present disclosure;

FIG. 3 is a cross-sectional view illustrating a configuration of a main portion of the optical unit according to the first embodiment of the present disclosure;

FIG. 4 is a cross-sectional view of the optical unit, taken along a line I-I in FIG. 3;

FIG. 5 is a perspective view illustrating a configuration of a fixing unit main body of the optical unit according to the first embodiment of the present disclosure;

FIG. 6 is a perspective view illustrating a configuration of a movable portion of the optical unit according to the first embodiment of the present disclosure;

FIG. 7 is a diagram illustrating a configuration of only a voice coil motor when viewed on a cutting plane passing through a line II-II illustrated in FIG. 4;

FIG. 8 is a diagram illustrating only the voice coil motor in the same cross-section as FIG. 4;

FIG. 9 is a plan view illustrating a configuration of the fixing unit main body of the optical unit according to the first embodiment of the present disclosure;

FIG. 10 is a cross-sectional view illustrating a configuration of a main portion of an optical unit according to a first modified example of the first embodiment of the present disclosure;

FIG. 11 is a cross-sectional view illustrating a configuration of a main portion of an optical unit according to a second modified example of the first embodiment of the present disclosure;

FIG. 12 is a cross-sectional view illustrating a configuration of a main portion of an optical unit according to a third modified example of the first embodiment of the present disclosure;

FIG. 13 is a cross-sectional view illustrating a configuration of a main portion of an optical unit according to a fourth modified example of the first embodiment of the present disclosure;

FIG. 14 is a cross-sectional view illustrating a configuration of a main portion of an optical unit according to a fifth modified example of the first embodiment of the present disclosure;

FIG. 15 is a cross-sectional view illustrating a configuration of a main portion of an optical unit according to a sixth modified example of the first embodiment of the present disclosure;

FIG. 16 is a cross-sectional view illustrating a configuration of a main portion of an optical unit according to a seventh modified example of the first embodiment of the present disclosure;

FIG. 17 is a cross-sectional view illustrating a configuration of a main portion of an optical unit according to an eighth modified example of the first embodiment of the present disclosure;

FIG. 18 is a schematic diagram illustrating a configuration of a main portion of an optical unit according to a ninth modified example of the first embodiment of the present disclosure;

FIG. 19 is a schematic diagram illustrating a configuration of a main portion of an optical unit according to a 10th modified example of the first embodiment of the present disclosure;

FIG. 20 is a schematic diagram illustrating a configuration of a main portion of an optical unit according to an 11th modified example of the first embodiment of the present disclosure;

FIG. 21 is a schematic diagram illustrating a configuration of a main portion of an optical unit according to a 12th modified example of the first embodiment of the present disclosure;

FIG. 22 is a schematic diagram illustrating a configuration of a main portion of an optical unit according to a 13th modified example of the first embodiment of the present disclosure;

FIG. 23 is a perspective view illustrating a configuration of an optical unit according to a 14th modified example of the first embodiment of the present disclosure;

FIG. 24 is a cross-sectional view of the optical unit, taken along a line III-III in FIG. 23;

FIG. 25 is a perspective view illustrating a configuration of an optical unit according to a 15th modified example of the first embodiment of the present disclosure;

FIG. 26 is a perspective view illustrating a configuration of an optical unit according to a 16th modified example of the first embodiment of the present disclosure;

FIG. 27 is a perspective view illustrating a configuration of an optical unit according to a 17th modified example of the first embodiment of the present disclosure;

FIG. 28 is a diagram illustrating a configuration of an optical unit according to a second embodiment of the present disclosure;

FIG. 29 is a diagram illustrating a configuration of an optical unit according to a third embodiment of the present disclosure;

FIG. 30 is a diagram illustrating a configuration of an endoscope system including an endoscope according to a fourth embodiment of the present disclosure; and

FIG. 31 is a diagram illustrating a configuration of a main portion of an endoscope in an endoscope system according to a modified example of the fourth embodiment of the present disclosure.

### DETAILED DESCRIPTION OF THE PREFERRED EMBODIMENTS

A mode for carrying out the present disclosure (hereinafter, referred to as an “embodiment”) will be described below.

### First Embodiment

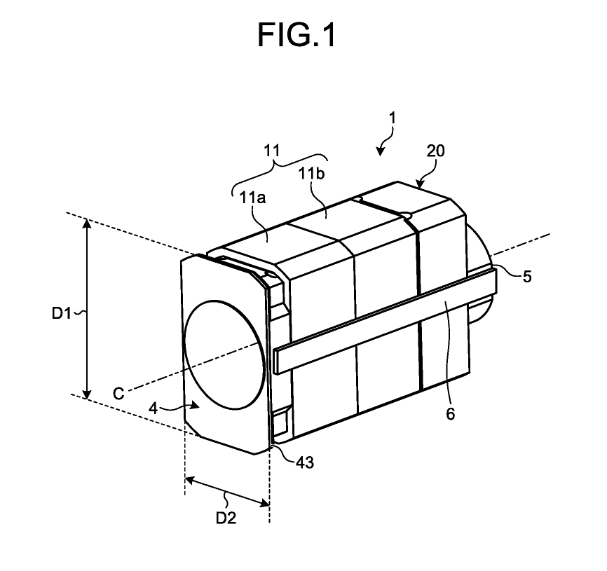

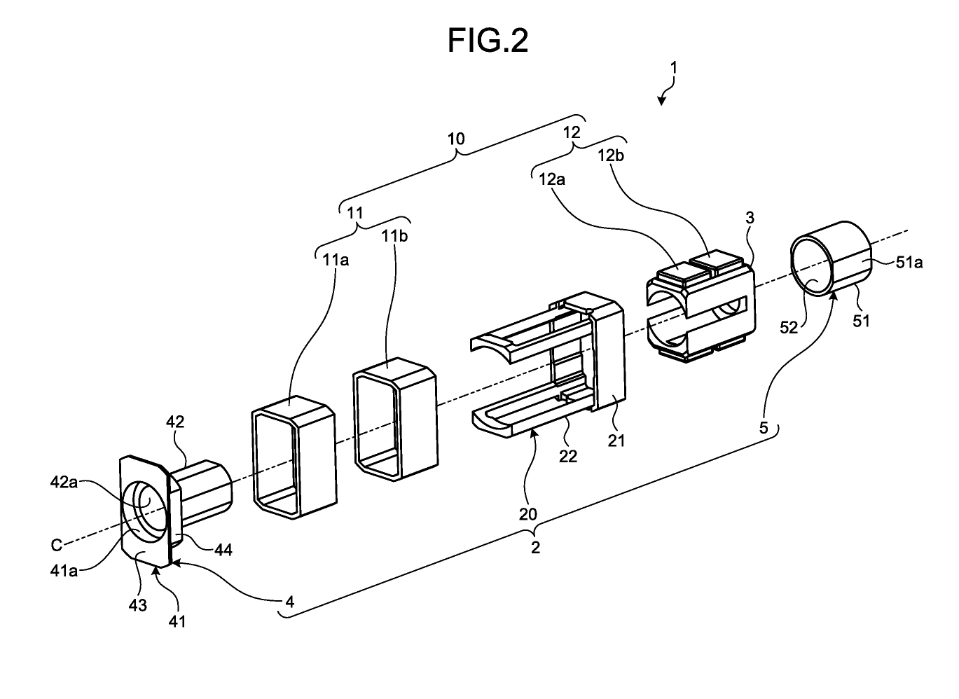

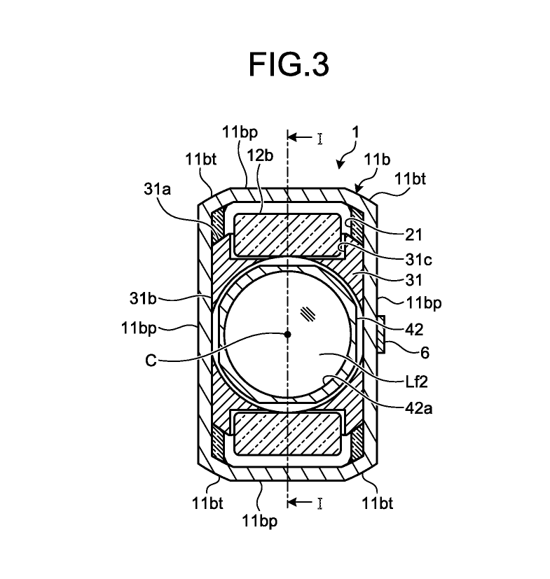

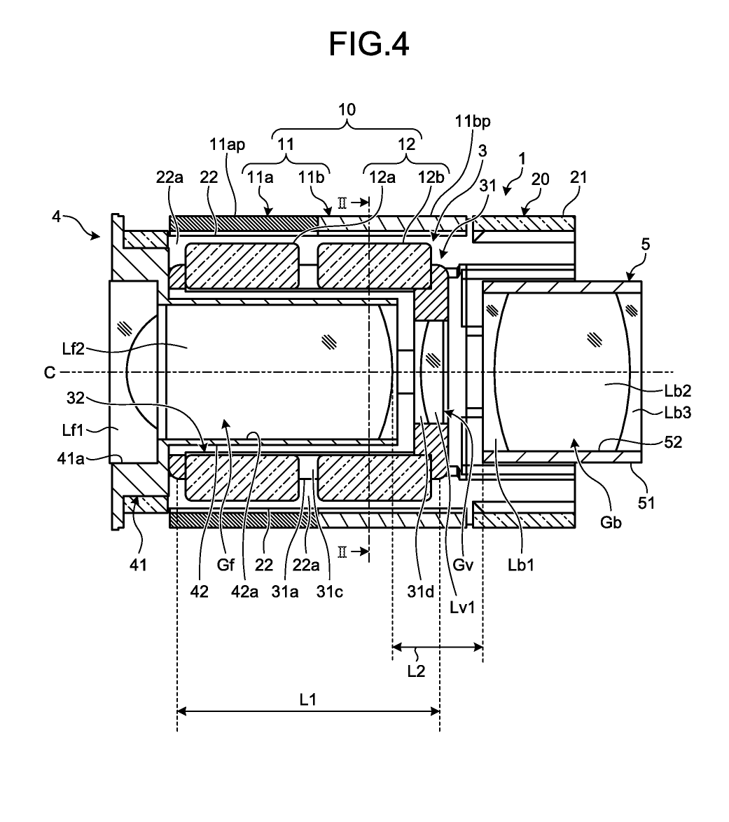

FIG. 1 is a perspective view illustrating a configuration of an optical unit according to a first embodiment of the present disclosure. FIG. 2 is an exploded perspective view illustrating a configuration of the optical unit according to the first embodiment of the present disclosure. FIG. 3 is a cross-sectional view illustrating a configuration of a main portion of the optical unit according to the first embodiment of the present disclosure. FIG. 4 is a cross-sectional view of the optical unit, taken along a line I-I in FIG. 3. In addition, FIG. 3 is also a cross-sectional view of the optical, taken along a line II-II in FIG. 4.

Referring to FIGS. 1 to 4, an optical unit 1 includes a fixing unit 2, a movable portion 3 movable with respect to the fixing unit 2, a voice coil motor 10 that generates drive force for moving the movable portion 3 with respect to the fixing unit 2, and a biasing member 6 that attracts the movable portion 3 closer to the fixing unit 2 thereby to bias the movable portion 3 toward the fixing unit 2. Hereinafter, one side in an axis C direction will be referred to as an object side, and the other side that is an opposite side of the object side will be referred to as an image side. In this specification, the description will be given assuming that an axis C is in agreement with an optical axis of the optical unit 1.

The fixing unit 2 includes a fixing unit main body 20, an anterior frame portion 4 that holds an object side fixed lens group Gf provided on the object side of a movable lens group Gv held by the movable portion 3, and is attached to the object side of the fixing unit main body 20, and a rear frame portion 5 that holds an image side fixed lens group Gb provided on the image side of the movable lens group Gv, and is attached to the image side of the fixing unit main body 20.

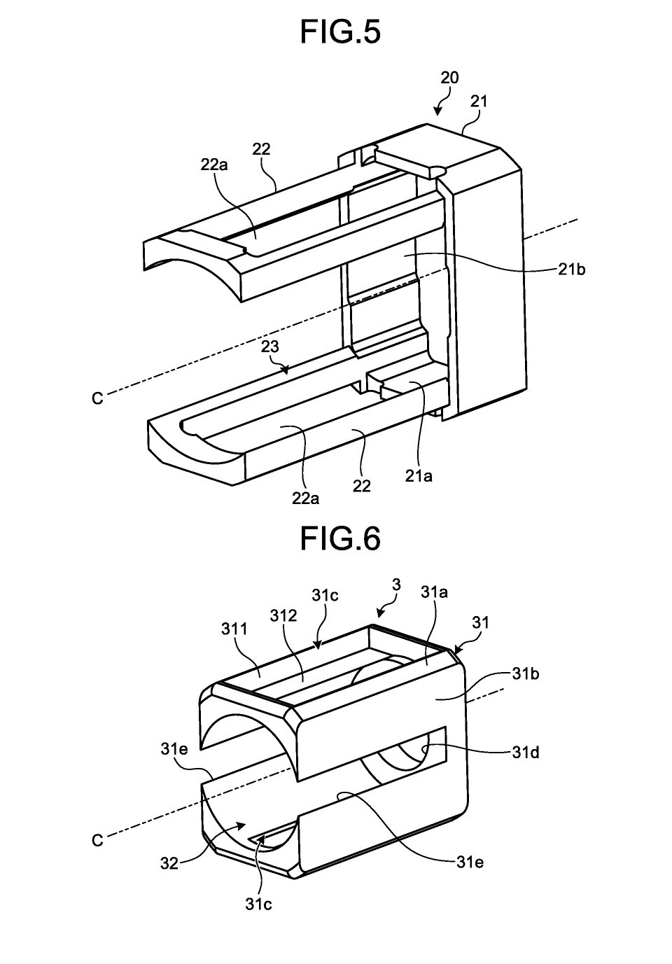

FIG. 5 is a perspective view illustrating a configuration of the fixing unit main body 20. The fixing unit main body 20 illustrated in FIG. 5 includes a tubular member centered on the axis C. The fixing unit main body 20 has a plane view shape of an oval coin, seen along the axis C, and has a tubular shape approximately symmetric about a plane that passes through the axis C and is parallel to the axis C, or approximately symmetric laterally or vertically. The fixing unit main body 20 includes a tubular portion 21 having a tubular shape having a central axis corresponding to the axis C, and a supporting portion 22 that extends toward the object side in the axis C direction with respect to the tubular portion 21, and supports a coil 11 (refer to FIG. 1 and the like) of the voice coil motor 10. Hereinafter, a plane that passes through the axis C and is parallel to the axis C will be referred to as a plane passing through the axis C. Here, the aforementioned oval coin shape has a shape of an octagon into which a rectangle is chamfered so that four C chamber planes are formed at four corners, or an octagon whose every other side is shorter, in a planar view in the axis C direction, as in the fixing unit main body 20, for example. Incidentally, in addition to the aforementioned shape with the C-chamfered four corners in a rectangle, the “oval coin shape” in this specification may include a shape formed by chamfering four corners of a rectangle so that four R chamfer planes (or round planes) are formed at four corners thereof. The “oval coin shape” may include a shape including alternatively an arc portion and a linear portion in a planar view in the axis C direction, as with the rear frame portion 5 to be mentioned later, and the like. In addition, the “oval coin shape” may refer to a shape whose dimensions are different in a magnetization direction of the voice coil motor 10 from in a direction perpendicular to the magnetization direction, in a plane perpendicular to the axis C direction, as mentioned later.

Moreover, the fixing unit main body 20 desirably has a tubular shape symmetric about a plane that passes through the axis C and is parallel to the axis C, but needs not be completely symmetric, and R (or curvature) of the R chamfered planes at corresponding corners may vary, for example.

In the tubular portion 21, a shape projected from the axis C direction (shape formed by an outer periphery and shape formed by an inner periphery) has the oval coin shape. The tubular portion 21 is larger than the supporting portion 22 in a radial direction (or a direction radially outward from the axis C in the plane perpendicular to the axis C). A groove 21a is formed on the inner side in the radial direction of the tubular portion 21. When the movable portion 3 is assembled, a magnet 12, which will be mentioned later, passes through the groove 21a. Thus, the movable portion 3 can be smoothly assembled to the fixing unit main body 20. In addition, the tubular portion 21 may be formed separately from the supporting portion 22, and attached to the supporting portion 22 when assembled.

In the supporting portion 22, a lightening portion 22a having a portion removed for lightening is formed. Specifically, two lightening portions 22a respectively penetrating in the radial direction of the supporting portions 22 are formed at positions facing each other with respect to the axis C (central axis) in a longitudinal direction of the supporting portion 22. A surface on the inner side in the radial direction of the supporting portion 22 that excludes the lightening portion 22a has a shape extending along an arc ellipse shape, to form a fixing side sliding surface 23 that guides and supports the movable portion 3. The fixing side sliding surface 23 has a shape divided in a circumferential direction by the lightening portion 22a. In addition, the surface on the inner side in the radial direction of the supporting portion 22 that excludes the lightening portion 22a needs not be a spherical surface, but may be a flat surface, or may be a curved surface with R (or a curvature) varying along the circumferential direction.

In the anterior frame portion 4, a shape projected from the axis C direction has the oval coin shape. The anterior frame portion 4 has a tubular shape approximately symmetric about a plane that is parallel to the axis C. The anterior frame portion 4 is a tubular member having a shape of a stepped (or flanged) cylinder and includes a distal end portion 41 and a proximal end portion 42. The distal end portion 41 includes a first distal end portion 43 and a tubular second distal end portion 44. The first distal end portion 43 has an opening, and an outer rim of a distal end thereof on the object side is of the oval coin shape equivalent to an outer rim of the tubular portion 21. The tubular second distal end portion 44 extends from the first distal end portion 43 along the axis C.

The proximal end portion 42 has a tubular shape extending from the second distal end portion 44. An inner periphery portion 41a of the distal end portion 41 defines a convex shaped hollow space having a large diameter on the object side. In addition, the central axis of the anterior frame portion 4 is referred to as the axis C in FIG. 2 and the like, because the central axis corresponds to the central axis of the fixing unit main body 20 in the assembling. In addition, the anterior frame portion 4 desirably has a tubular shape symmetric about a plane that is parallel to the axis C, but needs not be completely symmetric.

The anterior frame portion 4 holds the object side fixed lens group Gf. The object side fixed lens group Gf includes a first front lens Lf1 and a second front lens Lf2, which are arranged in this order from the object side. The inner periphery portion 41a of the distal end portion 41 holds the first front lens Lf1, and an inner periphery portion 42a of the proximal end portion 42 holds the second front lens Lf2.

At the time of assembling, the anterior frame portion 4 is inserted into the fixing unit main body 20, while the proximal end portion 42 is being fitted with a distal end portion on the object side of the supporting portion 22 of the fixing unit main body 20, until the distal end portion 41 is brought into contact with a distal end of the supporting portion 22 of the fixing unit main body 20.

The rear frame portion 5 has the oval coin shape in a planar view seen along the axis C direction. The rear frame portion 5 is a tubular member including an outer periphery portion 51 and an inner periphery portion 52. The outer periphery portion 51 has a notch portion 51a for fitting with the fixing unit main body 20. The rear frame portion 5 has a tubular shape approximately symmetric about a plane that passes through the axis C. In addition, similarly to the anterior frame portion 4, the central axis of the rear frame portion 5 is referred to as the axis C because the central axis corresponds to the central axis of the fixing unit main body 20 when assembled. In addition, the rear frame portion 5 desirably has a tubular shape symmetric about a plane that passes through the axis C, but needs not be completely symmetric.

The rear frame portion 5 holds the image side fixed lens group Gb. The image side fixed lens group Gb includes a first rear lens Lb1, a second rear lens Lb2, and a third rear lens Lb3. The inner periphery portion 52 holds the first rear lens Lb1, the second rear lens Lb2, and the third rear lens Lb3 in this order from the object side. When assembling, the rear frame portion 5 is inserted into the fixing unit main body 20, while the notch portion 51a is being fitted with a side portion 21b (FIG. 5) of the fixing side sliding surface 23 of the tubular portion 21.

The fixing unit 2 having the above configuration is formed of nonmagnetic material, for example. Examples of such material include austenite stainless having relative magnetic permeability of 1.0 or more, aluminum, and resin, among nonmagnetic materials.

FIG. 6 is a perspective view illustrating a configuration of the movable portion 3. The movable portion 3 illustrated in FIG. 6 is a bottomed tubular member including an outer periphery portion 31 and an inner periphery portion 32. Hereinafter, a central axis of the movable portion 3 will also be referred to as the axis C. This is because the central axis of the movable portion 3 and the central axis of the fixing unit main body 20 correspond to each other when assembled.

In the outer periphery portion 31, a shape projected from the axis C direction has the oval coin shape, and the outer periphery portion 31 includes a movable side sliding surface 31a having an outer peripheral surface that contacts the fixing unit main body 20, and a planar portion 31b connecting to the movable side sliding surface 31a. In the case illustrated in FIG. 6, in a direction perpendicular to the axis C direction and a normal line of the planar portion 31b, the movable portion 3 is provided with two lightening portions 31c. In addition, the movable portion 3 includes an opening 31d that is provided on one surface in the axis C direction (in a bottom portion of the one side bottomed tubular shape), and constitutes a part of the inner periphery portion 32, and a notch portion 31e obtained by cutting out part of the movable side sliding surface 31a along the axis C direction.

The lightening portions 31c includes a side portion 311 connecting to the movable side sliding surface 31a of the outer periphery portion 31, and a bottom portion 312 that is provided on the inner periphery portion 32 side, and has a surface approximately perpendicular to the side portion 311. The lightening portions 31c hold the magnet 12 to be mentioned later. In the movable portion 3, a plane that passes through an end portion on a side of the outer periphery portion 31 on which the magnet 12 is arranged (end portion on the lightening portions 31c side) intersects with the magnet 12. With this configuration, a thickness in the radial direction of the movable side sliding surface 31a in the movable portion 3 can be made thicker as compared with other portions, and rigidity and processing accuracy can be enhanced.

The movable portion 3 holds the movable lens group Gv. Specifically, the inner periphery portion 32 of the movable portion 3 holds a movable first lens Lv1 included in the movable lens group Gv.

The movable portion 3 is inserted into the fixing unit main body 20 while the movable side sliding surface 31a is being in contact with the fixing side sliding surface 23 of the fixing unit main body 20. In this first embodiment, when the movable portion 3 is moved nearest to the object side, the object side fixed lens group Gf is arranged in vicinity to the movable lens group Gv of the movable portion 3.

The movable portion 3 having the above configuration is formed by using material such as stainless, aluminum, or resin, for example.

As illustrated in FIG. 4, in the optical unit 1, in a direction extending along the axis C, a distance L1 from a position nearest to the object side on the movable side sliding surface 31a of the movable portion 3, to a position nearest to the image side is longer than a distance L2 from an exit surface of the object side fixed lens group Gf held by the anterior frame portion 4, to an entrance surface of the image side fixed lens group Gb held by the rear frame portion 5 (L1>L2). In addition, the distance from the position nearest to the object side of the movable side sliding surface 31a of the movable portion 3, to the position nearest to the image side does include chamfered portions.

The biasing member 6 a ferromagnetic member having a band shape, and attracts the movable portion 3 toward the fixing unit main body 20 side. The ferromagnetic member may be formed of, for example, iron, nickel, cobalt, or alloy composed mainly of iron, nickel, or cobalt. One end in the longitudinal direction of the biasing member 6 is fixed to a side surface of the anterior frame portion 4, and the other end thereof is fixed to a side surface of the fixing unit main body 20.

Next, a configuration of the voice coil motor 10 will be described. As illustrated in FIG. 4, the voice coil motor 10 includes the coil 11 disposed in the fixing unit main body 20 of the fixing unit 2, and the magnet 12 disposed in the movable portion 3 so as to face the coil 11.

As illustrated in FIGS. 3 and 4, the coil 11 includes a first coil 11a and a second coil 11b. The first coil 11a is winded around an outer periphery of the supporting portion 22 of the fixing unit main body 20. The second coil 11b is disposed alongside of the first coil 11a in the axis C direction, and winded around the outer periphery of the supporting portion 22 of the fixing unit main body 20. In addition, a pre-winded coil may be arranged as the coil 11, or the coil 11 may be directly winded around the supporting portion 22. The first coil 11a and the second coil 11b alongside of each other in the axis C direction are preferably connected in series, but may be connected in parallel.

As illustrated in FIG. 4, the first coil 11a and the second coil 11b respectively include planar portions 11ap and 11bp both of which face the lightening portions 22a of the fixing unit main body 20 (only the second coil 11b is exemplified in FIG. 3). In addition, the first coil 11a and the second coil 11b respectively include corner portions 11at and 11bt facing the supporting portion 22. In a cross-section perpendicular to the axis C, in the first coil 11a, four planar portions 11ap and four corner portions 11at are alternately disposed. Similarly, in a cross-section perpendicular to the axis C, in the second coil 11b, four planar portions 11bp and four corner portions 11bt are alternately disposed (refer to FIG. 3).

Referring to FIGS. 2 to 4, the magnet 12 includes two first magnets 12a (magnetic portions) and two second magnets 12b (second magnetic portions). Each of the first and second magnets 12a, 12b has a prismatic column shape and is disposed inside the first coil 11a and the second coil 11b. The two first magnets 12a are disposed so as to oppose the corresponding planer portions 11ap of the first coil 11a, and face each other with the axis C therebetween in a plane perpendicular to the axis C. Similarly, the two second magnets 12b are disposed so as to oppose the corresponding planer portions 11bp of the second coil 11b, and face each other with the axis C therebetween in a plane perpendicular to the axis C. The second magnets 12b are disposed alongside of the corresponding one of the first magnets 11a in the axis C direction. In addition, regarding the first magnets 12a (or the second magnets 12b), an angle formed by a line segment connecting the axis C and a center of one of the first magnets 12a (or the second magnets 12b) and another line segment connecting the axis C and a center of the other one of the first magnets 12a (or the second magnets 12b) may be 180°, as shown in FIG. 3, but may be an angle other than 180°.

As illustrated in FIG. 4, a total of widths in the axis C direction of the first magnets 12a and the second magnets 12b is shorter than a total of widths in the axis C direction of the first coil 11a and the second coil 11b. With this configuration, within a moving range of the movable portion 3, the first magnets 12a and the second magnets 12b can be kept within the widths in the axis C direction of the first coil 11a and the second coil 11b.

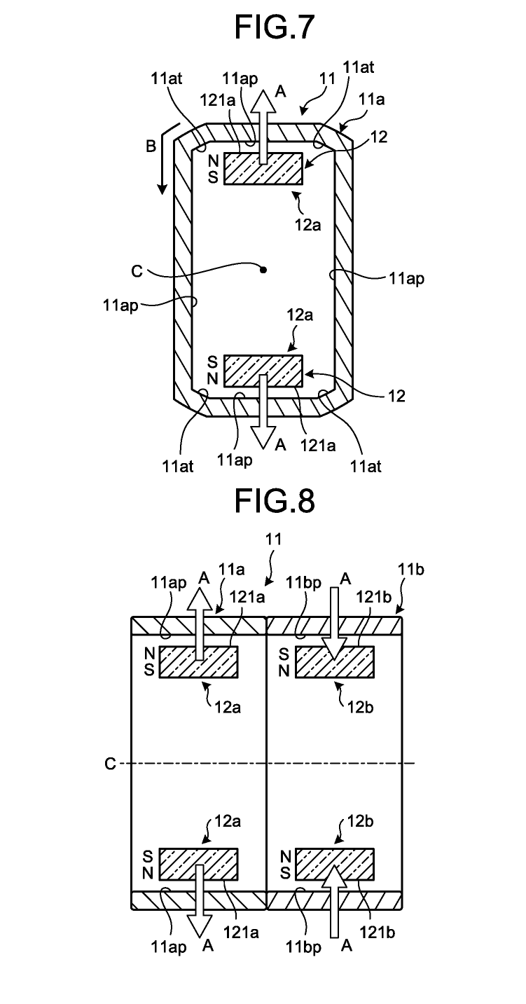

FIG. 7 is a cross-sectional view, taken along a line II-II in FIG. 4, illustrating a configuration of only a voice coil motor. FIG. 8 is a diagram illustrating only the voice coil motor on the same cross-section as FIG. 4.

As illustrated in FIGS. 7 and 8, the first magnet 12a and the second magnet 12b that form a pair along the axis C direction are disposed at a distance from each other. A pair of the first magnets 12a and a pair of the second magnets 12b are magnetized in the radial direction. A magnetization direction of one of the first magnets 12a is opposite to that of the other one of the first magnets 12a. Similarly, a magnetization direction of one of the second magnets 12b is opposite to that of the other one of the second magnet 12b. In the case illustrated in FIGS. 7 and 8, each of the first magnets 12a has the N pole on the first coil 11a side, and the S pole on the opposite side, and each of the second magnets 12b has the S pole on the second coil 11b side, and the N pole on the opposite side. In this case, magnetic polarization directions of the first magnets 12a and the second magnets 12b are perpendicular to the axis C as indicated by white arrows A illustrated in FIGS. 7 and 8. In addition, more generally, magnetic polarization directions of the first magnets 12a and the second magnets 12b are only required to be directions intersecting with the axis C.

In this first embodiment, in the coil 11, winding directions are preferably reversed between the pair of the first magnets 12a and the pair of the second magnets 12b. For example, as illustrated in FIG. 7, when the first coil 11a is winded in a direction indicated by an arrow B, the second coil 11b is only required to be winded in the opposite direction. Alternatively, the winding direction of the first coil 11a and the second coil 11b may be made equal, and the first coil 11a and the second coil 11b may be connected such that current directions become opposite. In this case, as illustrated in FIG. 7, when current flows in the first coil 11a in the direction indicated by the arrow B, current is only required to flow in the second coil 11b in a direction opposite to the arrow B.

In the optical unit 1 having the above configuration, on the inner side in the radial direction of the fixing unit main body 20 around which the first coils 11a are winded, the movable portion 3 in which the first magnets 12a are installed so as to respectively face the first coils 11a is disposed. Thus, each of the planar portions 11ap of the first coils 11a exists in a magnetic field in a direction perpendicular to a surface 121a on the outside in the radial direction of the first magnet 12a. In addition, the second magnet 12b is similarly formed. Thus, drive efficiency is enhanced, and the movable portion 3 can be swiftly moved. In addition, by making the surface 121a on the outside in the radial direction of the first magnet 12a, and a surface 121b on the outside in the radial direction of the second magnet 12b planar, assembling of the optical unit 1 can be easily performed.

In addition, if current flows in the coil 11 of the optical unit 1, due to the influence of a magnetic field of the magnet 12, force in the axis C direction is generated in the movable portion 3, and the movable portion 3 moves in the axis C direction with respect to the fixing unit 2. For example, by controlling currents that flow in the first coil 11a and the second coil 11b, the movable portion 3 can be moved with respect to the fixing unit 2. Even in a state in which the movable portion 3 is moving with respect to the fixing unit 2, a surface on the outside in the radial direction of the magnet 12 is disposed in the lightening portion 22a of the fixing unit main body 20.

In addition, in the optical unit 1, as illustrated in FIG. 4, the outer peripheral surface of the movable portion 3 forms the movable side sliding surface 31a that contacts the fixing side sliding surface 23 of the fixing unit main body 20. By bringing the fixing side sliding surface 23 of the fixing unit main body 20 and the movable side sliding surface 31a of the movable portion 3 into contact, the movable portion 3 can be moved in a state in which the movable portion 3 is always in contact with the fixing unit main body 20, and the movable portion 3 can be prevented from being inclined with respect to the fixing unit 2. Therefore, the movable portion 3 can be appropriately moved.

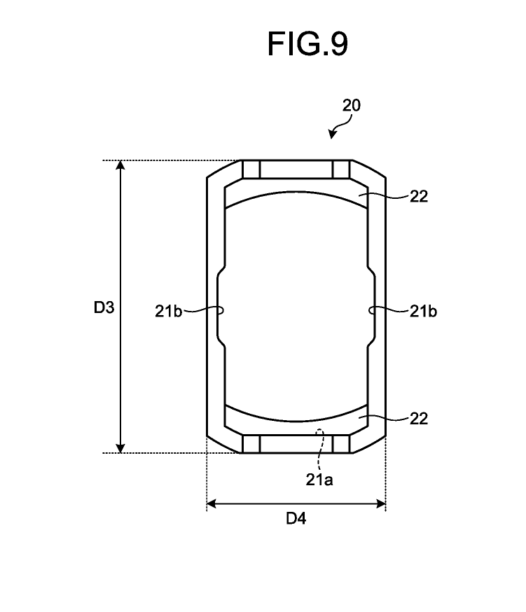

FIG. 9 is a plan view illustrating a configuration of the fixing unit main body of the optical unit according to the first embodiment of the present disclosure, and is a diagram illustrating the tubular portion 21 viewed from the object side in the axis C direction. In this first embodiment, as illustrated in FIG. 1, in the first distal end portion 43, a maximum dimension D1 in a magnetization direction of the magnet 12 (direction in which the magnets 12 face: first direction) is longer than a maximum dimension D2 in a direction (second direction) perpendicular to the magnetization direction and the axis C direction. In addition, in the tubular portion 21 of the fixing unit main body 20, as illustrated in FIG. 9, a maximum dimension D3 in the magnetization direction of the magnet 12 is longer than a maximum dimension D4 in the direction perpendicular to the magnetization direction and the axis C direction. In addition, because the coil 11 (the first coil 11a and the second coil 11b) is winded around the supporting portion 22, in a shape formed by the winding (shape viewed in the axis C direction), a maximum dimension in the magnetization direction of the magnet 12 is longer than a maximum dimension in the direction perpendicular to the magnetization direction and the axis C direction. Here, when the optical unit 1 is viewed from the anterior frame portion 4 side along the axis C direction, a part of the movable portion 3, a part of the coil 11, or a part of the magnet 12 is included inside the anterior frame portion 4.

A ratio (D2/D1) of the maximum dimension D2 with respect to the maximum dimension D1 is preferably 0.4≤(D2/D1)≤0.8, and is more preferably 0.5≤(D2/D1)≤0.7. Similarly, a ratio (D4/D3) of the maximum dimension D4 with respect to the maximum dimension D3 is preferably 0.4≤(D4/D3)≤0.8, and is more preferably 0.5≤(D4/D3)≤0.7. As mentioned above, the optical unit 1 according to this first embodiment has the oval coin shape in a planar view viewed in the axis C direction. Similarly, as for the movable portion 3, the second distal end portion 44, and the rear frame portion 5, a shape (planar view) viewed in the axis C direction (central axis direction of each portion) has preferably the oval coin shape in which a maximum dimension in the magnetization direction of the magnet 12 is longer than a maximum dimension in the direction perpendicular to the magnetization direction and the axis C direction. Here, in the optical unit 1, at least a shape formed by the outer periphery of the tubular portion 21 of the fixing unit main body 20 (shape formed by the outer periphery viewed from the axis C direction) is only required to have the oval coin shape. In this case, shapes of components other than the fixing unit main body 20 are not limited to oval coin shapes as long as the components have shapes that can be assembled to each other.

In the optical unit 1, attracting force caused by magnetism acts between the biasing member 6 and the magnet 12, and the magnet 12 is attracted toward the biasing member 6. With this configuration, a position of the movable portion 3 in the fixing unit main body 20 that is a position of the movable portion 3 in a plane perpendicular to the axis C direction can be adjusted, and a shift in position of the movable portion 3 in the plane can be suppressed. In addition, in this first embodiment, the biasing member 6 is provided at an approximately-center portion in the first direction in the optical unit 1, and is provided such that the longitudinal direction extends along the axis C direction.

According to the first embodiment of the present disclosure described above, the voice coil motor 10 that includes the coil 11 disposed in the fixing unit 2 and the magnet 12 disposed in the movable portion 3 to be magnetically polarized in the direction perpendicular to the axis C, and can move the movable portion 3 in the axis C direction with respect to the fixing unit 2 is included. Thus, drive efficiency is enhanced, and the movable portion 3 can be swiftly actuated. In addition, by bringing the fixing side sliding surface 23 of the fixing unit main body 20 and the movable side sliding surface 31a of the movable portion 3 into contact even during the actuation of the movable portion 3, inclination of the movable portion 3 with respect to the fixing unit 2 can be suppressed, so that the movable portion 3 can be appropriately moved. Thus, downsizing and weight saving of an actuator that drives a movable lens to move forward and backward can be achieved.

In addition, according to this first embodiment, because attracting force caused by magnetism acts between the magnet 12 and the biasing member 6 formed of magnetic material, and the magnet 12 is attracted toward the biasing member 6 side, a shift in a position of the movable portion 3 in the fixing unit main body 20 that is a position of the movable portion 3 in the plane perpendicular to the axis C direction can be suppressed, and inclination of the movable portion 3 with respect to the fixing unit main body 20 can be thereby suppressed. Therefore, drive stability can be enhanced. With this configuration, drive force to be applied to the voice coil motor 10 may be reduced. Furthermore, by fixing a position of the movable portion 3 in the fixing unit main body 20, decentering of an optical system can be suppressed, and performance degradation caused by the decentering can be suppressed.

In addition, according to this first embodiment, because the fixing side sliding surface 23 is provided on an inner diameter side (inner peripheral surface) of the fixing unit main body 20, and the movable portion 3 is disposed on an inner diameter side of the fixing unit 2 (the fixing unit main body 20), downsizing in the radial direction can be achieved.

In addition, according to this first embodiment, because the central axis of the fixing unit 2 and the central axis of the movable portion 3 correspond to the axis C, and have the central axis equal to each other, inclination of the movable portion 3 with respect to the fixing unit 2 can be thereby suppressed. With this configuration, driving of the optical unit 1 can be stabilized, and downsizing in the radial direction can be achieved.

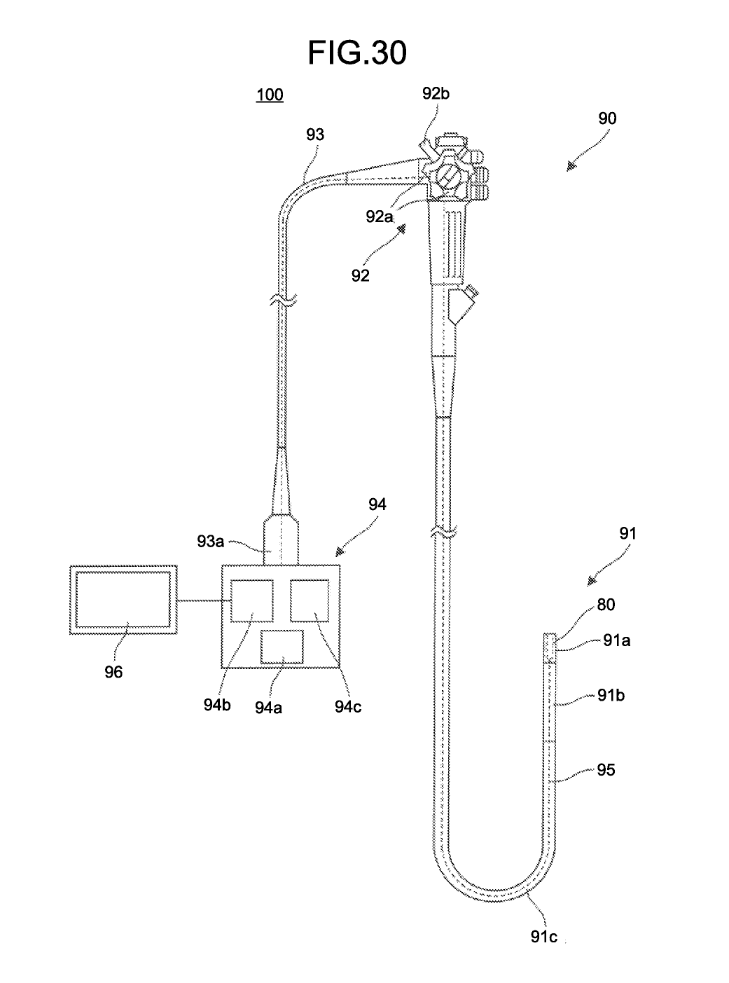

In addition, according to this first embodiment, because the optical unit 1 has the oval coin shape in a planar view viewed from the axis C direction, downsizing in the radial direction, more specifically, in a direction perpendicular to the direction in which two pairs of the magnets 12 face can be achieved. Thus, as illustrated in FIG. 30 to be mentioned later, for example, when the optical unit 1 is disposed at a distal end of an endoscope, the distal end of the endoscope can be downsized, which is favorable. Furthermore, because the biasing member 6 is disposed in a direction perpendicular to the direction in which two pairs of the magnets 12 downsized by the oval coin shape face, a maximum outer diameter of the optical unit 1 can be reduced. Thus, similarly to the effect of the oval coin shape, it is favorable in disposing in the endoscope distal end, and the distal end of the endoscope can be downsized.

In addition, according to this first embodiment, because the magnets 12 are arranged in the lightening portions 31c of the movable portion 3, downsizing in a direction in which the two pairs of the magnets 12 face can be achieved.

In addition, according to this first embodiment, because the fixing unit 2 is constructed with the fixing unit main body 20, the anterior frame portion 4, and the rear frame portion 5, the number of components and the number of assembling processes can be reduced. In addition, degrees of freedom in design can be increased, so that cost saving can be achieved.

Moreover, according to this first embodiment, in the optical unit 1, because the distance L1 from a position nearest to the object side on the movable side sliding surface 31a of the movable portion 3, to a position nearest to the image side is longer than the distance L2 from an exit surface of the object side fixed lens group Gf held by the anterior frame portion 4, to an entrance surface of the image side fixed lens group Gb held by the rear frame portion 5 in a direction extending along the axis C, inclination of the movable portion 3 with respect to the fixing unit 2 can be suppressed. With this configuration, driving of the optical unit 1 can be stabilized, and downsizing in the axis direction can be achieved.

In addition, according to this first embodiment, because the coil 11 is winded with the axis C being placed at the center, a sliding axis of the movable portion 3 and an actuation axis of driving force generated by the voice coil motor 10 can be identical, and stable driving can be performed.

In addition, according to this first embodiment, because the fixing side sliding surface 23 of the fixing unit 2 is formed with being divided in the circumferential direction, the optical unit 1 can be downsized with a simple structured.

In addition, according to this first embodiment, the fixing unit main body 20 is divided into two parts, namely, the supporting portions 22, at one end side in the axis C direction, and holds the proximal end portion 42 of the anterior frame portion 4. With this configuration, rigidity of the fixing unit 2 can be enhanced without increasing a size in the radial direction. In addition, because the anterior frame portion 4 is closely attached and held by one end side of the fixing unit main body 20, a shape of an end portion the supporting portion 22, the end portion being on the side opposite to the tubular portion 21, is determined accordingly. In addition, the shape of the fixing side sliding surface 23 can be also determined accordingly. With this configuration, the optical unit 1 can stably operate, and downsizing in the radial direction can be achieved.

In addition, according to this first embodiment, because the plural magnets 12 are disposed symmetrically about the axis C, drive force can be stably increased.

In addition, according to this first embodiment, the magnets 12 include a plurality of pairs each including the first magnet 12a and the second magnet 12b that are adjacent to each other in the axis C direction, and have magnetic polarization directions opposite to each other; the plural first magnets 12a have the same magnetic polarization direction; the coil 11 includes the first coils 11a facing the plurality of first magnets 12a, and the second coils 11b facing the plurality of second magnets 12b, and connected to the first coils 11a; and currents flow in the first coils 11a and the second coils 11b in opposite directions. Therefore, drive force can be increased.

In addition, in this first embodiment, the magnets 12 (the first magnet 12a and the second magnet 12b) are preferably divided in the circumferential direction of the optical unit 1 (winding direction of the coil 11). In other words, the magnets 12 are preferably discontinuous in a cross-sectional plane perpendicular to the axis C.

### First Modified Example of First Embodiment

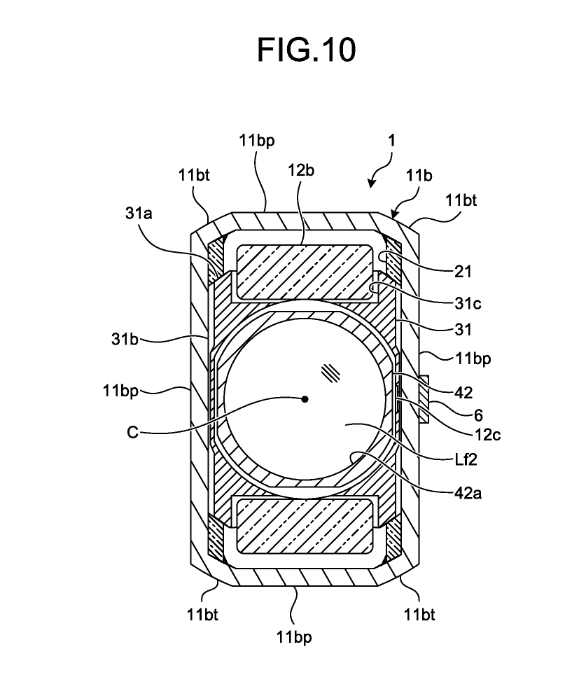

FIG. 10 is a cross-sectional view illustrating a configuration of a main portion of an optical unit according to a first modified example of the first embodiment, specifically, a cross-sectional view of the optical unit, taken along a line corresponding to the line II-II in FIG. 4. In this first modified example, in contrast to the aforementioned configuration of the optical unit 1, in the movable portion 3, a third magnet 12c is provided on a side surface (the planar portion 31b) in a direction in which the two first magnets 12a face, and in a direction (second direction) perpendicular to the axis C direction. By providing the third magnet 12c in the second direction while maintaining a shape of the optical unit 1 in a planar view viewed from the axis C direction to the oval coin shape, downsizing of the optical unit can be achieved, and performance as a voice coil motor can be enhanced.

Subsequently, second to eighth modified examples of this first embodiment will be described. In the aforementioned first embodiment, the description has been given assuming that, in the optical unit 1, the biasing member 6 is provided on the outer periphery side of the fixing unit 2, and at an approximately-center portion in the first direction, and is provided such that the longitudinal direction extends along the axis C direction. However, the biasing member 6 is not limited to this.

### Second Modified Example of First Embodiment

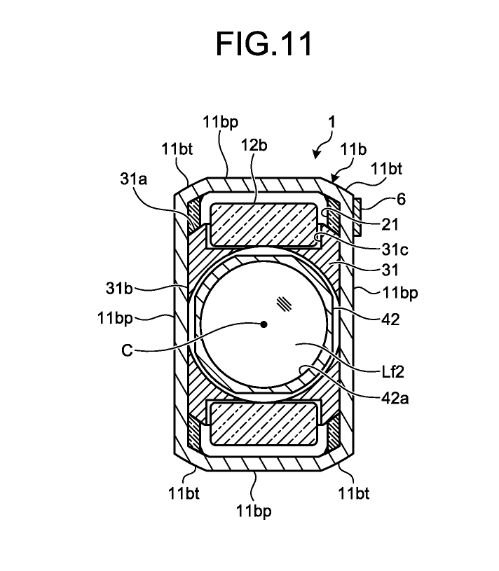

FIG. 11 is a cross-sectional view illustrating a configuration of a main portion of an optical unit according to a second modified example of the first embodiment, specifically, a cross-sectional view of the optical unit, taken along a line corresponding to the line II-II in FIG. 4. In this second modified example, the aforementioned biasing member 6 is provided not at an approximately-center portion in the first direction, but at a portion on one end portion side. In this manner, a position in the first direction of the biasing member 6 is not limited to the center portion, and the biasing member 6 may be disposed at other positions.

### Third Modified Example of First Embodiment

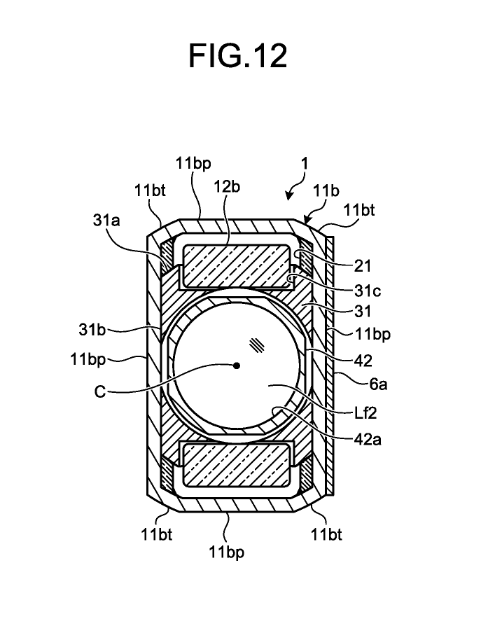

FIG. 12 is a cross-sectional view illustrating a configuration of a main portion of an optical unit according to a third modified example of the first embodiment, specifically, a cross-sectional view of the optical unit, taken along a line corresponding to the line II-II in FIG. 4. In this third modified example, in place of the aforementioned biasing member 6, a biasing member 6a having a length (width) in the first direction that is larger than that of the biasing member 6 is included. A width of the biasing member is only required to be smaller than a length in the first direction of the optical unit 1, and may be, for example, a width smaller than a distance between the two second magnets 12b, as with the biasing member 6 according to the first embodiment, or may be a width larger than this distance.

### Fourth Modified Example of First Embodiment

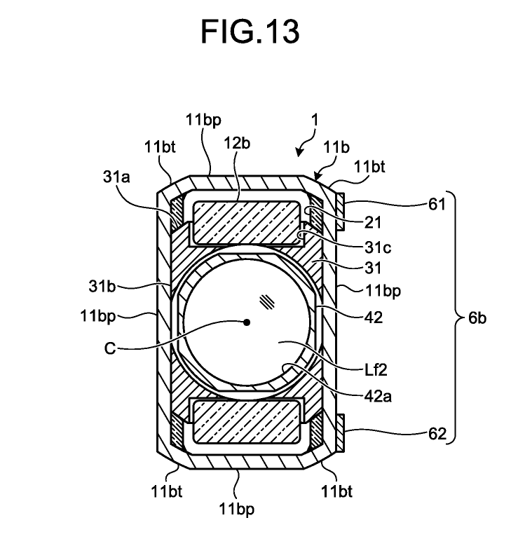

FIG. 13 is a cross-sectional view illustrating a configuration of a main portion of an optical unit according to a fourth modified example of the first embodiment, specifically, a cross-sectional view of the optical unit, taken along a line corresponding to the line II-II in FIG. 4. In this fourth modified example, in place of the aforementioned biasing member 6, a biasing member 6b including two biasing members (a first biasing member 61 and a second biasing member 62) arranged along the first direction is included. The number of biasing members not limited as long as the biasing members can be attached to the fixing unit 2. For example, the number of biasing members may be one as with the biasing member 6 according to the first embodiment, or may be two as with this fourth modified example.

### Fifth Modified Example of First Embodiment

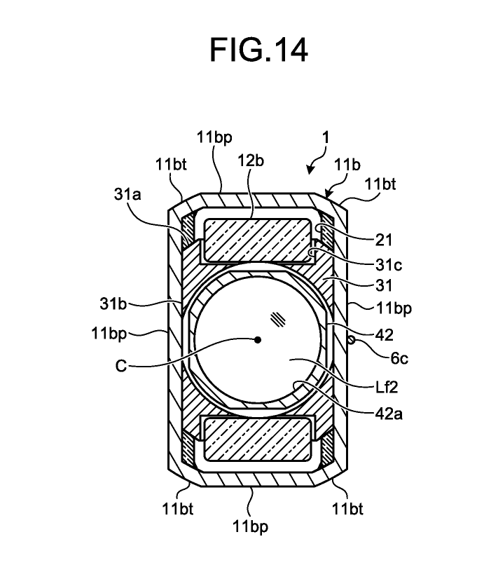

FIG. 14 is a cross-sectional view illustrating a configuration of a main portion of an optical unit according to a fifth modified example of the first embodiment, specifically, a cross-sectional view of the optical unit, taken along a line corresponding to the line II-II in FIG. 4. In this fifth modified example, in place of the aforementioned biasing member 6, a biasing member 6c extending like a rod is included. The shape of the biasing member is not limited to a band shape, for example, and may be a shape extending like a rod, as with this fifth modified example, or a cross-section perpendicular to the longitudinal direction may have a square shape. When a rod-like wire as with this fifth modified example is used, as compared with a band-like member, processing difficulty of a biasing member can be reduced while appropriately adjusting an amount of force related to attraction, and variations in manufacturing can be reduced.

### Sixth Modified Example of First Embodiment

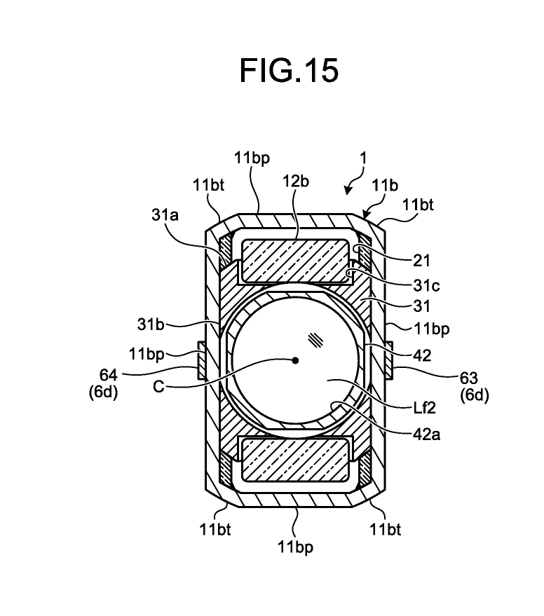

FIG. 15 is a cross-sectional view illustrating a configuration of a main portion of an optical unit according to a sixth modified example of the first embodiment, specifically, a cross-sectional view of the optical unit, taken along a line corresponding to the line II-II in FIG. 4. In this sixth modified example, in place of the aforementioned biasing member 6, a biasing member 6d including two biasing members (a third biasing member 63 and a fourth biasing member 64) facing in the second direction, and having different attracting forces generated by the magnetic portion is included. The third biasing member 63 and the fourth biasing member 64, which face each other, include the axis C therebetween. In other words, the third biasing member 63 and the fourth biasing member 64 are provided on the both sides with respect to the optical axis. As with this sixth modified example, the number and arrangement of biasing members is not limited as long as the biasing members can be attached to the fixing unit 2, and for example, two biasing members may be provided at positions facing in the second direction. Attracting force generated between the biasing member and the magnetic portion (the magnet 12) can be adjusted by a distance between the biasing member and the magnetic portion, a shape and material of the biasing member, and the like.

### Seventh Modified Example of First Embodiment

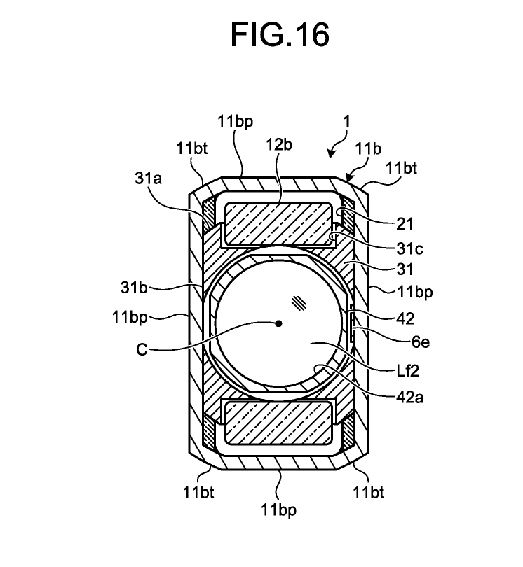

FIG. 16 is a cross-sectional view illustrating a configuration of a main portion of an optical unit according to a seventh modified example of the first embodiment, specifically, a cross-sectional view of the optical unit, taken along a line corresponding to the line II-II in FIG. 4. In this seventh modified example, in place of the aforementioned biasing member 6, a biasing member 6e provided on an inner periphery side of the fixing unit 2 is included. The biasing member is only required to be disposed at a position at which the movable portion 3 can be attracted toward the fixing unit main body 20, and for example, as with the biasing member 6 according to the first embodiment, the biasing member may be provided on the outer periphery side of the fixing unit 2, or may be provided on the inner periphery side as with this seventh modified example.

### Eighth Modified Example of First Embodiment

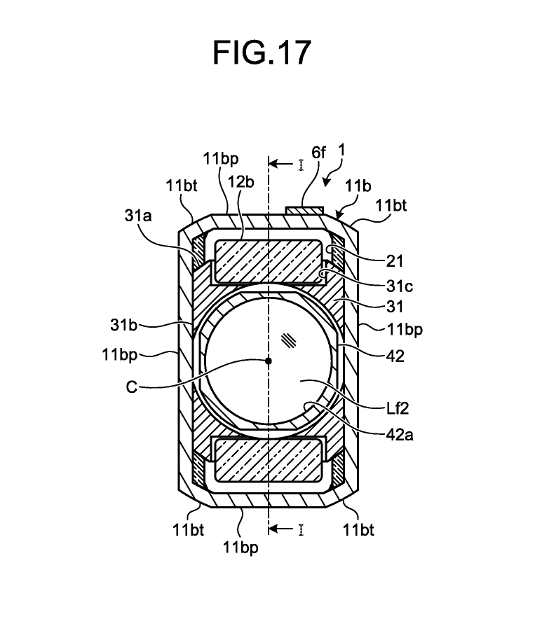

FIG. 17 is a cross-sectional view illustrating a configuration of a main portion of an optical unit according to an eighth modified example of the first embodiment, specifically, a cross-sectional view of the optical unit, taken along a line corresponding to the line II-II in FIG. 4. In this eighth modified example, in place of the aforementioned biasing member 6, a biasing member 6f provided on an upper outer periphery side of the fixing unit 2 is included. The biasing member is only required to be disposed at a position at which the movable portion 3 can be attracted toward the fixing unit main body 20, and for example, as with the biasing member 6 according to the first embodiment, the biasing member may be provided on the outer periphery side of the fixing unit 2, or may be provided on a side surface intersecting with the first direction of the fixing unit main body 20 as with this eighth modified example.

Subsequently, ninth to 13th modified examples of this first embodiment will be described. In the aforementioned first embodiment, the description has been given assuming that the biasing member 6 has a plate shape in which a surface having the widest area (hereinafter, referred to as a principal surface) is a rectangular, but the biasing member 6 is not limited to this.

### Ninth Modified Example of First Embodiment

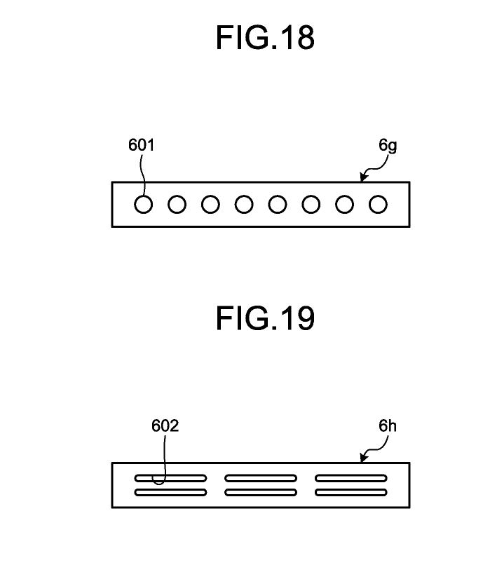

FIG. 18 is a schematic diagram illustrating a configuration of a main portion of an optical unit according to a ninth modified example of the first embodiment of the present disclosure. In this ninth modified example, in place of the aforementioned biasing member 6, a biasing member 6g in which a plurality of through-holes 601 are formed along the longitudinal direction is included. Each of the through-holes 601 is circular in planar view.

### Tenth Modified Example of First Embodiment

FIG. 19 is a schematic diagram illustrating a configuration of a main portion of an optical unit according to a 10th modified example of the first embodiment of the present disclosure. In this 10th modified example, in place of the aforementioned biasing member 6, a biasing member 6h in which a plurality of through-holes 602 are formed in two lines along the longitudinal direction is included. The through-hole 602 is an elongate hole extending in the longitudinal direction of the biasing member 6h. By forming through-holes as with these ninth and 10th modified examples, the biasing member can be downsized.

### Eleventh Modified Example of First Embodiment

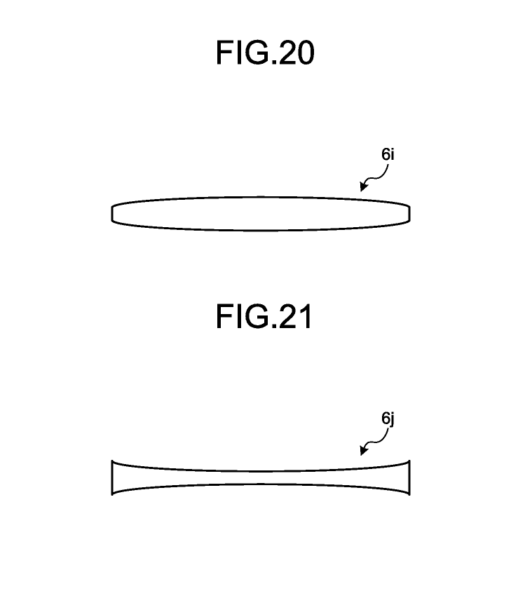

FIG. 20 is a schematic diagram illustrating a configuration of a main portion of an optical unit according to an 11th modified example of the first embodiment of the present disclosure. In this 11th modified example, in place of the aforementioned biasing member 6, a biasing member 6i in which an outer rim extending along the longitudinal direction is arc-shaped is included. As in this 11th modified example, a biasing member having a shape in which a width of a center portion in the longitudinal direction becomes the largest may be used.

### Twelfth Modified Example of First Embodiment

FIG. 21 is a schematic diagram illustrating a configuration of a main portion of an optical unit according to a 12th modified example of the first embodiment of the present disclosure. In this 12th modified example, in place of the aforementioned biasing member 6, a biasing member 6j in which an outer rim extending along the longitudinal direction is arc-shaped is included. As in this 12th modified example, a biasing member having a shape in which a width of a center portion in the longitudinal direction becomes the smallest may be used.

### Thirteenth Modified Example of First Embodiment

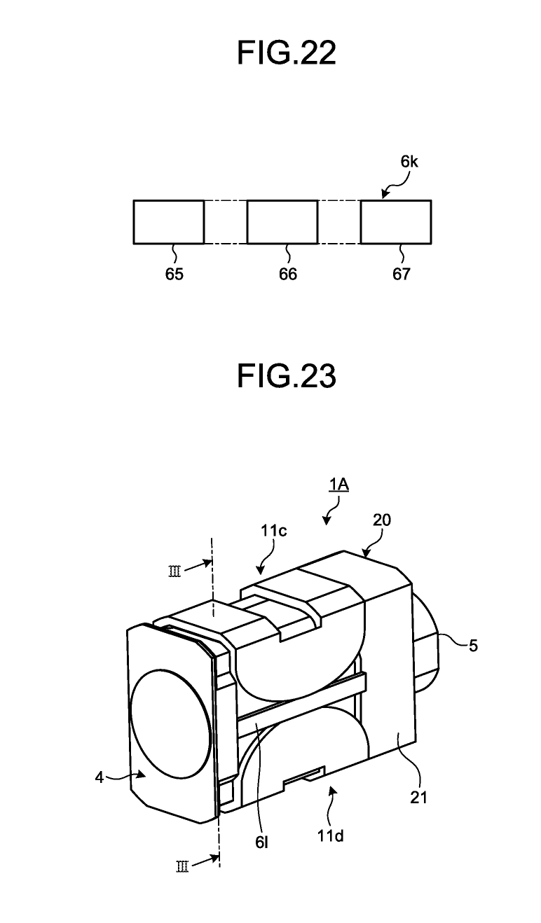

FIG. 22 is a schematic diagram illustrating a configuration of a main portion of an optical unit according to a 13th modified example of the first embodiment of the present disclosure. In this 13th modified example, in place of the aforementioned biasing member 6, a biasing member 6k including a plurality of biasing members (a fifth biasing member 65, a sixth biasing member 66, and a seventh biasing member 67) that are separated from one another in the longitudinal direction is included. As in this 13th modified example, the number of biasing members disposed along the longitudinal direction is not limited to one, and a plurality of biasing members may be provided. In this case, each of the biasing members may be attached to the fixing unit 2. Alternatively, adjacent ones of the biasing members may be connected to each other by an insulating connection member.

### Fourteenth Modified Example of First Embodiment

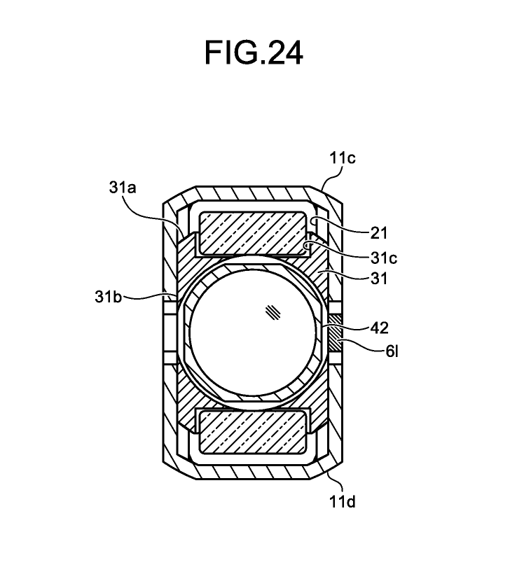

Subsequently, a 14th modified example of this first embodiment will be described. FIG. 23 is a perspective view illustrating a configuration of an optical unit according to a 14th modified example of the first embodiment of the present disclosure. FIG. 24 is a cross-sectional view of the optical unit, taken along a line III-III in FIG. 23. In the aforementioned first embodiment, the description has been given assuming that the biasing member 6 passes through the outer periphery of the coil 11, but in this 14th modified example, coils are divided along the first direction, and a biasing member is provided between the coils. Specifically, an optical unit 1A according to this 13th modified example includes, in place of the first coil 11a and the second coil 11b, a third coil 11c provided on one side in the first direction, and a fourth coil 11d provided on the other side. In addition, the optical unit 1A includes, in place of the biasing member 6, a biasing member 61 provided between the third coil 11c and the fourth coil 11d, and connecting the anterior frame portion 4 and the tubular portion 21. By providing the biasing member 61 between the third coil 11c and the fourth coil 11d as in this 14th modified example, as compared with the optical unit 1 according to the first embodiment, downsizing can be achieved.

Subsequently, 15th to 17th modified examples of this first embodiment will be described. In the aforementioned first embodiment, the description has been given assuming that the first magnet 12a and the second magnet 12b have a prismatic shape, but the shape is not limited to this.

### Fifteenth Modified Example of First Embodiment

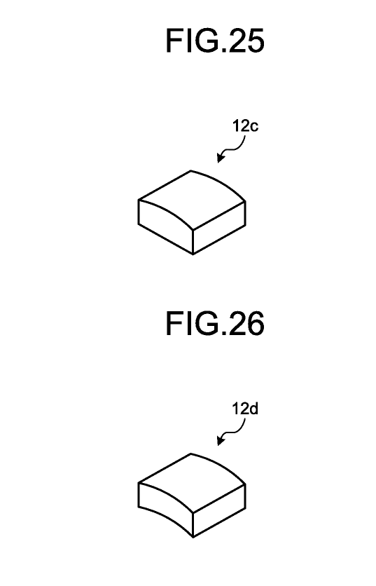

FIG. 25 is a schematic diagram illustrating a configuration of a main portion of an optical unit according to a 15th modified example of the first embodiment of the present disclosure, and is a perspective view illustrating a configuration of a magnet of a voice coil motor. As in the magnet 12c according to this 15th modified example, an outer peripheral surface may include a curved surface.

### Sixteenth Modified Example of First Embodiment

FIG. 26 is a schematic diagram illustrating a configuration of a main portion of an optical unit according to a 16th modified example of the first embodiment of the present disclosure, and is a perspective view illustrating a configuration of a magnet of a voice coil motor. As in a magnet 12d according to this 16th modified example, facing surfaces among outer peripheral surfaces may have an arch shape forming a curved surface.

### Seventeenth Modified Example of First Embodiment

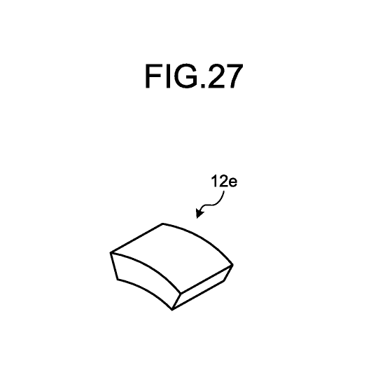

FIG. 27 is a schematic diagram illustrating a configuration of a main portion of an optical unit according to a 17th modified example of the first embodiment of the present disclosure, and is a perspective view illustrating a configuration of a magnet of a voice coil motor. As in a magnet 12e according to this 17th modified example, facing surfaces among outer peripheral surfaces may have an arch shape forming a curved surface. In addition, lengths along the arch shape may be different in one of the arch-shaped facing surfaces from in the other one of the arch-shaped facing surfaces.

### Second Embodiment

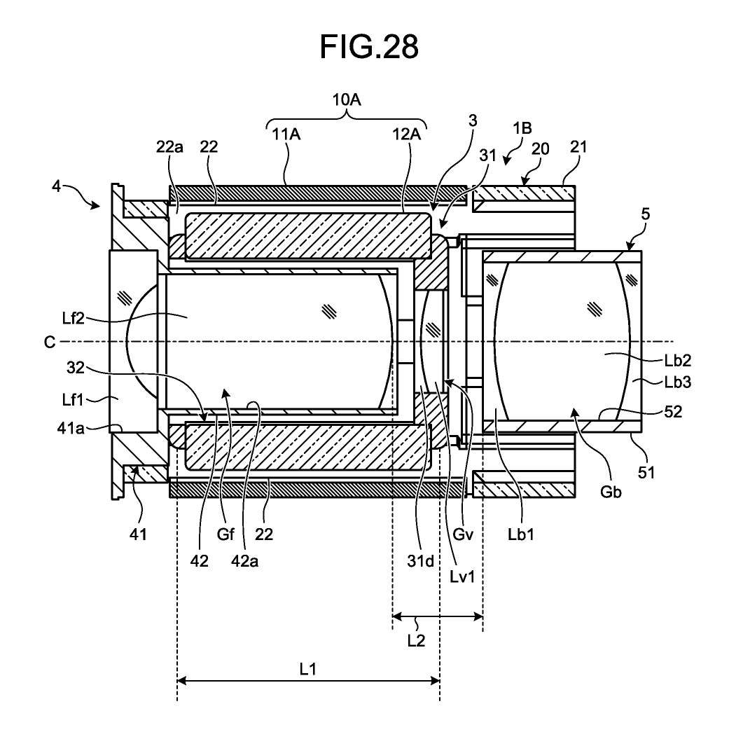

FIG. 28 is a diagram illustrating a configuration of an optical unit according to a second embodiment of the present disclosure, and is a cross-sectional view of the optical unit, taken along a line corresponding to the line I-I in FIG. 3. In addition, the same signs are given to the same components as the aforementioned configurations. In the aforementioned first embodiment, the description has been given assuming that the first coil 11a and the second coil 11b that are arranged along the axis C direction, and have different winding directions, and two pairs of the first magnets 12a and the second magnets 12b are included. However, one pair of magnets (magnetic portion) may be provided, or three or more pairs of magnets may be provided. In this second embodiment, an example of including one pair of magnets will be described. An optical unit 1B illustrated in FIG. 28 includes the fixing unit 2, the movable portion 3 movable with respect to the fixing unit 2, the biasing member 6 that can adjust a position of the movable portion 3 by biasing the movable portion 3 in a direction in which the movable portion 3 moves closer to the fixing unit 2, and a voice coil motor 10A that generates drive force for moving the movable portion 3 with respect to the fixing unit 2.

As illustrated in FIG. 28, the voice coil motor 10A includes a coil 11A disposed in the fixing unit main body 20 of the fixing unit 2, and a magnet 12A disposed in the movable portion 3 so as to face the coil 11A.

As illustrated in FIG. 28, the coil 11A includes a coil winded around the outer periphery of the supporting portion 22 of the fixing unit main body 20 along a predetermined direction. Incidentally, a pre-winded coil may be arranged as the coil 11A, or the coil 11A may be directly winded around the supporting portion 22. Except for the number of windings of the coil, the coil 11A may have a shape (shape viewed in the axis C direction, etc.) similar to the aforementioned first coil 11a and the second coil 11b.

As illustrated in FIG. 28, the magnet 12A includes a pair of magnets facing planar portions of the coil 11A, on the inner side of the coil 11A. The pair of magnets 12A (magnetic portions) are arranged at facing positions in a cross-section perpendicular to the axis C. In addition, in this second embodiment, the magnets 12A are installed at positions facing with respect to the axis C, but the magnets 12A may be installed so as to form an angle other than 180°.

As illustrated in FIG. 28, a width in the axis C direction of the magnets 12A is shorter than a width in the axis C direction of the coil 11A. With this configuration, within a moving range of the movable portion 3, the magnets 12A can be kept within the width of the coils 11A in the axis C direction.

In the optical unit 1B, similarly to the first embodiment, as illustrated in FIG. 28, in a direction extending along the axis C, a distance L1 from a position nearest to the object side on the movable side sliding surface 31a of the movable portion 3, to a position nearest to the image side is longer than a distance L2 from an exit surface of the object side fixed lens group Gf held by the anterior frame portion 4, to an entrance surface of the image side fixed lens group Gb held by the rear frame portion 5 (L1>L2).

### Third Embodiment

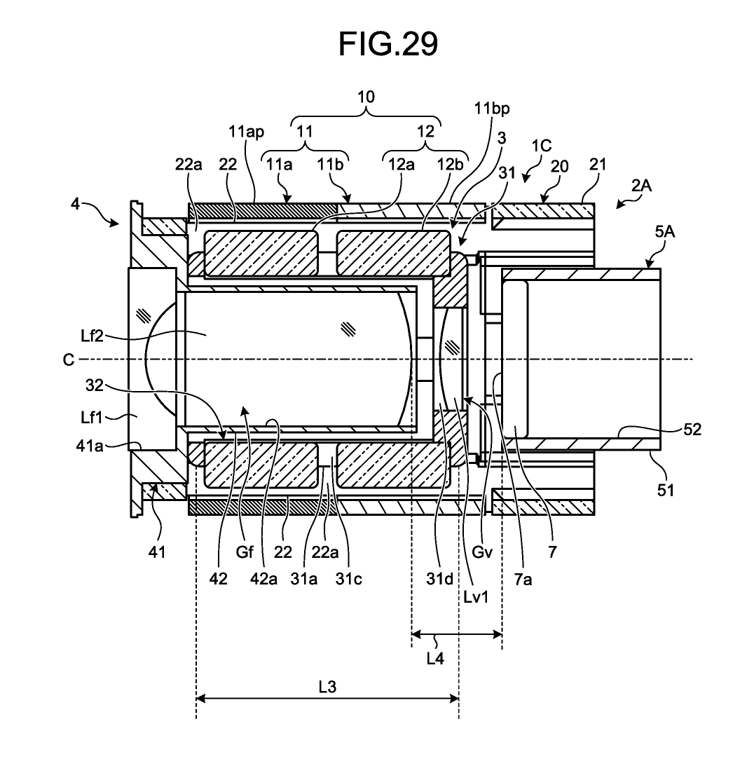

FIG. 29 is a diagram illustrating a configuration of an optical unit according to a third embodiment of the present disclosure, and is a cross-sectional view of the optical unit, taken along a line corresponding to the line I-I in FIG. 3. In addition, the same signs are given to the same components as the aforementioned configurations. An optical unit 1C illustrated in FIG. 29 includes a fixing unit 2A, the movable portion 3 movable with respect to the fixing unit 2A, the biasing member 6 that adjusts a position of the movable portion 3 with respect to the fixing unit 2A, and a voice coil motor 10 that generates drive force for moving the movable portion 3 with respect to the fixing unit 2A.

The fixing unit 2A includes the fixing unit main body 20, the anterior frame portion 4, and a rear frame portion 5A that holds an image sensor 7 and is attached to the image side of the fixing unit main body 20. The image sensor 7 is realized by a charge coupled device (CCD) or a complementary metal oxide semiconductor (CMOS), and performs photoelectric conversion processing by receiving light transmitted through the movable lens group Gv.

As illustrated in FIG. 29, in the optical unit 1C, in a direction extending along the axis C, a distance L3 from a position nearest to the object side on the movable side sliding surface 31a of the movable portion 3, to a position nearest to the image side is longer than a distance L4 from an exit surface of the object side fixed lens group Gf held by the anterior frame portion 4, to a light receiving surface 7a of the image sensor 7 that is held by the rear frame portion 5A (L3>L4).

### Fourth Embodiment

FIG. 30 is a diagram illustrating a configuration of an endoscope system including an endoscope according to a fourth embodiment of the present disclosure. An endoscope system 100 illustrated in FIG. 30 includes an endoscope 90, a control device 94, and a display device 96. The endoscope 90 may include the optical unit 1, 1A, 1B, or 1C according to the aforementioned first to third embodiments, and modified examples. In this fourth embodiment, the description will be given assuming that the optical unit 1 is included (not illustrated in FIG. 30), for example.

The endoscope 90 can be introduced into a subject such as a human body, and optically captures an image of a predetermined observed region inside the subject. In addition, the subject into which the endoscope 90 is introduced is not limited to a human body, and may be another biological body, or may be an artificial material such as a machine and a building. In other words, the endoscope 90 may be a medical endoscope, or may be an industrial endoscope.

The endoscope 90 includes an insertion portion 91 to be introduced into the inside of the subject, an operating unit 92 positioned at a proximal end of the insertion portion 91, and a universal cord 93 serving as a composite cable that extends from the operating unit 92.

The insertion portion 91 includes a distal end portion 91a arranged at a distal end, a curve portion 91b that is arranged at a proximal end side of the distal end portion 91a and can be freely curved, and a flexible tube portion 91c having flexibility that is arranged at a proximal end side of the curve portion 91b and connected to a distal end side of the operating unit 92. An imaging unit 80 that collects light from an object to be imaged and captures an image of the object is provided in the distal end portion 91a. The imaging unit 80 includes the optical unit 1 that collects light from the object, and an image sensor that performs photoelectric conversion on the light collected by the optical unit 1, to output a converted signal. In addition, in the case of using the optical unit 1C, the image sensor 7 is assumed to be provided inside the optical unit 1C (FIG. 29). The image sensor is formed by using a CCD or a CMOS. In addition, the endoscope 90 may be a rigid endoscope not including the flexible tube portion 91c in the insertion portion 91.

The operating unit 92 includes an angle operating unit 92a that operates a curve state of the curve portion 91b, and a zoom operating unit 92b that instructs actuation of the aforementioned voice coil motor 10, and performs a zoom operation in the optical unit 1. The angle operating unit 92a has a knob shape, and the zoom operating unit 92b has a lever shape, but they may have another form such as a volume switch and a push switch.

The universal cord 93 is a member that connects the operating unit 92 and the control device 94. The endoscope 90 is connected to the control device 94 via a connector 93a provided at a proximal end portion of the universal cord 93.

A cable 95 such as a wire, an electrical wire, and an optical fiber is inserted into the insertion portion 91, the operating unit 92, and the universal cord 93.

The control device 94 includes a drive control unit 94a that controls a curve state of the curve portion 91b, an image control unit 94b that controls the imaging unit 80, and a light source control unit 94c that controls a light source device (not illustrated). The control device 94 includes a processor such as a central processing unit (CPU), and comprehensively controls the entire endoscope system 100.

The drive control unit 94a includes an actuator, and is mechanically connected with the operating unit 92 and the curve portion 91b via a wire. The drive control unit 94a controls a curve state of the curve portion 91b by moving the wire forward and backward.

The image control unit 94b is electrically connected with the imaging unit 80 and the operating unit 92 via an electrical wire. The image control unit 94b performs drive control of the voice coil motor 10 included in the imaging unit 80, and processing of an image captured by the imaging unit 80. An image processed by the image control unit 94b is displayed on the display device 96.

The light source control unit 94c is optically connected with the light source and the operating unit 92 via an optical fiber. The light source control unit 94c controls brightness or the like of the light source that is emitted from the distal end portion 91a.

In addition, the operating unit 92 may be provided separately from the insertion portion 91, and may remotely operate the insertion portion 91.

Because the endoscope system 100 having the above configuration includes the imaging unit 80 including the aforementioned optical unit 1, 1A, 1B, or 1C, the endoscope system 100 is compact and can swiftly change zooming, and is preferable for capturing moving images.

In addition, in the endoscope system 100, the optical unit 1, 1A, 1B, or 1C is downsized in the radial direction, more specifically, in a direction perpendicular to the direction in which two pairs of the magnets 12 face each other, because of its oval coin shape in a planar view viewed from the axis C direction. Therefore, a diameter of the imaging unit 80 can be made small.

In addition, according to the endoscope system 100, because the magnet 12 is provided in the movable portion 3, whereas the coil 11 is provided in the fixing unit 2, cable connected to the coil 11 needs not be moved. Thus, there is no concern that a cable moves in a limited space of the distal end portion 91a of the endoscope 90, to cause cable disconnection, thereby to provide sufficient durability.

### Modified Example of Fourth Embodiment

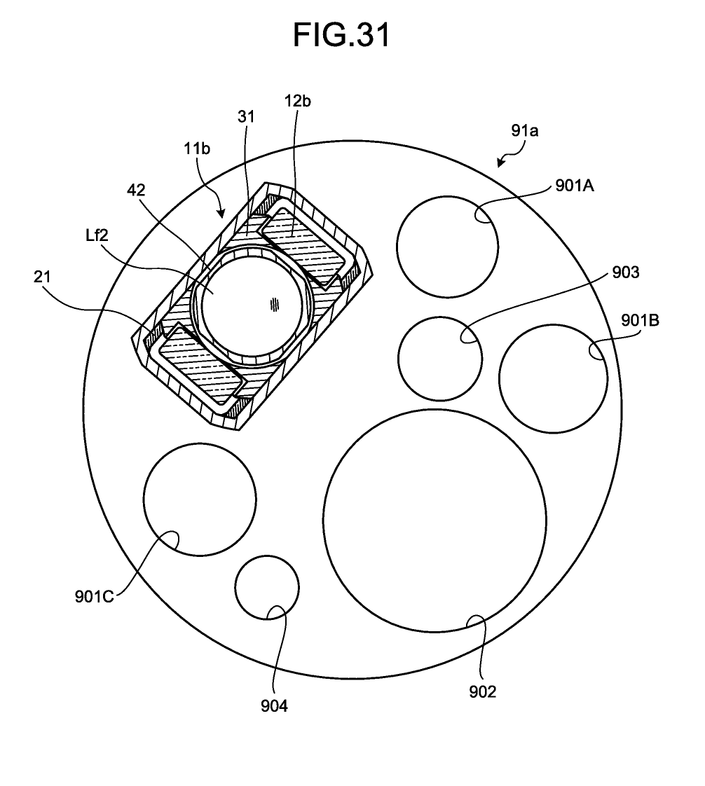

Subsequently, a modified example of this fourth embodiment will be described. FIG. 31 is a diagram illustrating a configuration of a main portion of an endoscope in an endoscope system according to a modified example of the fourth embodiment of the present disclosure. Specifically, FIG. 31 illustrates a cross-section of the imaging unit 80, taken along a line corresponding to the line II-II in FIG. 4. In this modified example, the imaging unit 80 includes the optical unit 1 excluding the biasing member 6. The distal end portion 91a includes light guides 901A, 901B, and 901C for guiding illumination light from the light source device, and emitting the light to the outside, a forceps channel 902 through which a biopsy forceps or the like is inserted, an air/water supply tube 903 that allows air or water to be supplied to the outside, a spray channel 904 that allow medicine or the like to be sprayed to outside, and the imaging unit 80 including the optical unit 1 excluding the biasing member 6. In this modified example, functions of the biasing member 6 in the optical unit are demonstrated by any of the aforementioned light guides 901A, 901B, and 901C, the forceps channel 902, the air/water supply tube 903, and the spray channel 904. Specifically, by providing a ferromagnetic film on a surface of a member by which the functions of the biasing member 6 are demonstrated, or by forming the member itself of ferromagnetic material, the movable portion 3 is attracted to, and biased to the fixing unit main body 20. In this manner, inner members of the endoscope 90 may be used as a biasing member.

### Other Embodiments

A mode for carrying out the present disclosure has been described so far. However, the present disclosure is not to be limited only by the aforementioned embodiments (and examples). For example, the aforementioned optical unit 1 may further include at least one magnetic detector that detects magnetic field, and a current control unit that controls current flowing in the coil 11, based on a detection result of the magnetic detector. The magnetic detector may be, for example, a hall element, or a magnetoresistance effect element (MR element). The magnetism detector may be fixedly installed on a support member provided on the outer periphery side in the radial direction of the coil 11. By controlling current flowing in the coil 11, based on the magnetic field detected by the magnetic detector, a driving speed and a stop position of the movable portion 3 can be controlled further accurately.

In addition, the number of magnets arranged in a movable portion is not limited to the number described in the first embodiment.

In addition, a lightening portion provided in a fixing unit needs not penetrate to the outer periphery side in the radial direction, as long as a magnet can be housed therein.

In addition, the first to fourth embodiments and the modified examples may be appropriately combined.

According to the present disclosure, downsizing and weight saving of an actuator that drives a movable lens to move forward and backward can be achieved, and operation stability can be ensured.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical unit comprising:
a fixing unit including an anterior frame portion holding an object side fixed lens group, a rear frame portion holding an image side fixed lens group or an image sensor, and a fixing unit main body holding the anterior frame portion and the rear frame portion;
a movable portion holding a movable lens group between the object side fixed lens group and the image side fixed lens group or the image sensor, the movable portion being disposed on an inner side in a radial direction of the fixing unit main body and slidable with respect to the fixing unit main body;
a voice coil motor that allows the movable portion to move along a direction of the optical axis relative to the fixing unit main body, the voice coil motor including:
a magnetic portion being disposed in the movable portion and magnetically polarized in a direction intersecting with an optical axis of the object side fixed lens group; and
a coil being disposed in the fixing unit main body and positioned on an outside in the radial direction of the fixing unit main body with respect to the magnetic portion; and
a biasing member configured to bias the movable portion in a direction in which the movable portion moves closer to the fixing unit main body, by attracting force generated between the magnetic portion and the biasing member,
wherein, in the fixing unit main body, a first dimension in a first direction parallel to a magnetization direction of the magnetic portion is longer than a second dimension in a second direction perpendicular to the first direction and the direction of the optical axis.

2. The optical unit according to claim 1,
wherein the biasing member is provided on a side surface of the fixing unit main body, the side surface intersecting with the second direction.

3. The optical unit according to claim 1,
wherein the biasing member includes:
a first biasing member provided on one side surface of the fixing unit main body; and
a second biasing member provided on another side surface intersecting with the second direction of the fixing unit main body, and
wherein the one side surface and the another side surface intersects with the second direction the first, and second biasing members are provided at positions facing each other with respect to the optical axis.

4. The optical unit according to claim 1,
wherein the coil includes:
a first coil provided on one side in the first direction with respect to the fixing unit main body; and
a second coil provided on another side in the first direction with respect to the fixing unit main body, and
wherein the biasing member is provided between the first and second coils.

5. The optical unit according to claim 1,
wherein, in a direction extending along the optical axis, a distance from a position nearest to an object side on a movable side sliding surface of the movable portion, to a position nearest to an image side is longer than a distance from an exit surface of the object side fixed lens group held by the fixing unit, to an entrance surface of the image side fixed lens group or a light receiving surface of an image sensor.

6. The optical unit according to claim 1,
wherein, when viewed from the anterior frame portion side along the optical axis direction,
a part of the movable portion, a part of the coil, or a part of the magnetic portion is included inside the anterior frame portion,
wherein the magnetic portion is disposed in the movable portion, and
wherein the coil is disposed in the fixing unit.

7. The optical unit according to claim 1,
wherein the fixing unit main body include:
a tubular portion having a tubular shape; and
a supporting portion extending from the tubular portion along the optical axis, to support the coil, and
wherein a lightening portion is formed in at least part of the supporting portion.

8. The optical unit according to claim 7,
wherein the fixing unit is divided along a circumferential direction on one end side in the direction of the optical axis, and
wherein the anterior frame portion and the rear frame portion are held on the one end side and on the other end side, respectively.

9. An endoscope for observing an inside of a subject by being inserted into the inside of the subject, the endoscope comprising:
the optical unit according to claim 1; and
an image sensor configured to convert light collected by the optical unit, into an electrical signal.

10. The endoscope according to claim 9,
wherein the biasing member is a ferromagnetic member provided inside the endoscope.
